(19) United States
(12) Patent Application Publication
(10) Pub. No.: US 2015/0169760 A1
(43) Pub. Date: Jun. 18, 2015

(54) Using Social Communities to Improve Search Results

(71) Applicant: International Business Machines Corporation, Armonk, NY (US)

(72) Inventors: Kristin M. Arrowood, Raleigh, NC (US); Kent F. Hayes, JR., Chapel Hill, NC (US); Joseph N. Kozhaya, Morrisville, NC (US); Douglas A. Williams, Durham, NC (US)

(73) Assignee: International Business Machines Corporation, Armonk, NY (US)

(21) Appl. No.: 14/132,223

(22) Filed: Dec. 18, 2013

(51) Int. Cl. G06F 17/30

(52) U.S. Cl. CPC G06F 17/30864

(57) ABSTRACT

An approach is provided for an information handling system to use social groups to improve search results. In the approach, a user interface is displayed that allows a user to specify a search criteria and one or more social groups. Data stores are then searched for the search criteria with the searching resulting in a set of search results. The search results are compared to previously tagged search results, with the previously tagged search results being results that were previously tagged by members of the specified social groups. Based on the comparing, set of search results is identified that match the previously tagged search results. The search results are displayed at the user interface with the identified set of one or more search results being visually highlighted, such as displayed first, at the user interface.

### BACKGROUND OF THE INVENTION

Today, many users are members of, or otherwise involved in social groups. These groups may be accessed through a social network or other web site. Oftentimes social groups pertain to a particular interest, vocation, or hobby shared amongst the members of the group. Consequently, a given user might be a member of several different social groups. Some of these groups might be work related, family related, or related to a particular interest or hobby of the user.

### SUMMARY

An approach is provided for an information handling system to use social groups to improve search results. In the approach, a user interface is displayed that allows a user to specify a search criteria and one or more social groups. Data stores are then searched for the search criteria with the searching resulting in a set of search results. The search results are compared to previously tagged search results, with the previously tagged search results being results that were previously tagged by members of the specified social groups. Based on the comparing, set of search results is identified that match the previously tagged search results. The search results are displayed at the user interface with the identified set of one or more search results being visually highlighted, such as displayed first, at the user interface.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a network environment that includes a knowledge manager that utilizes a knowledge base;

FIG. 2 is a block diagram of a processor and components of an information handling system such as those shown in FIG. 1;

FIG. 3 is a screen diagram depicting search result pages that use social groups to improve network search results;

FIG. 4 is a depiction of a flowchart showing the logic performed when processing a search received from a user that is a member of one or more social groups; and

FIG. 5 is a depiction of a flowchart showing the logic performed to handle a user action corresponding to a displayed search result.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

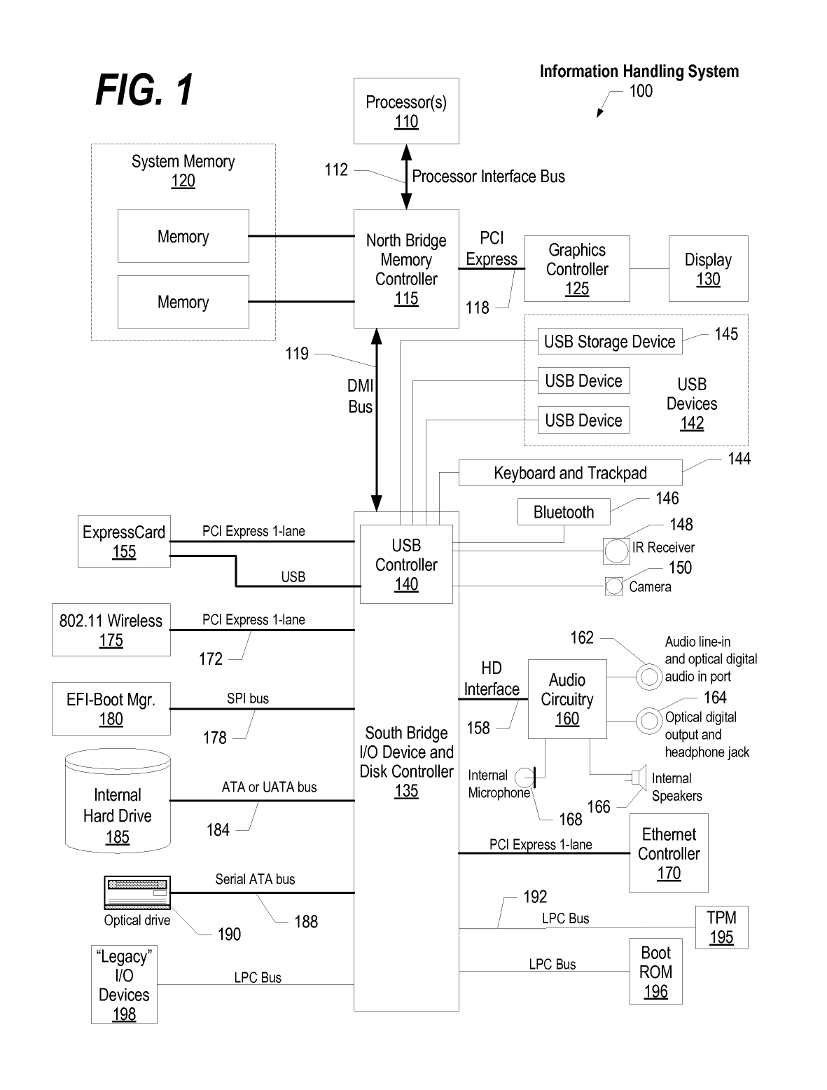

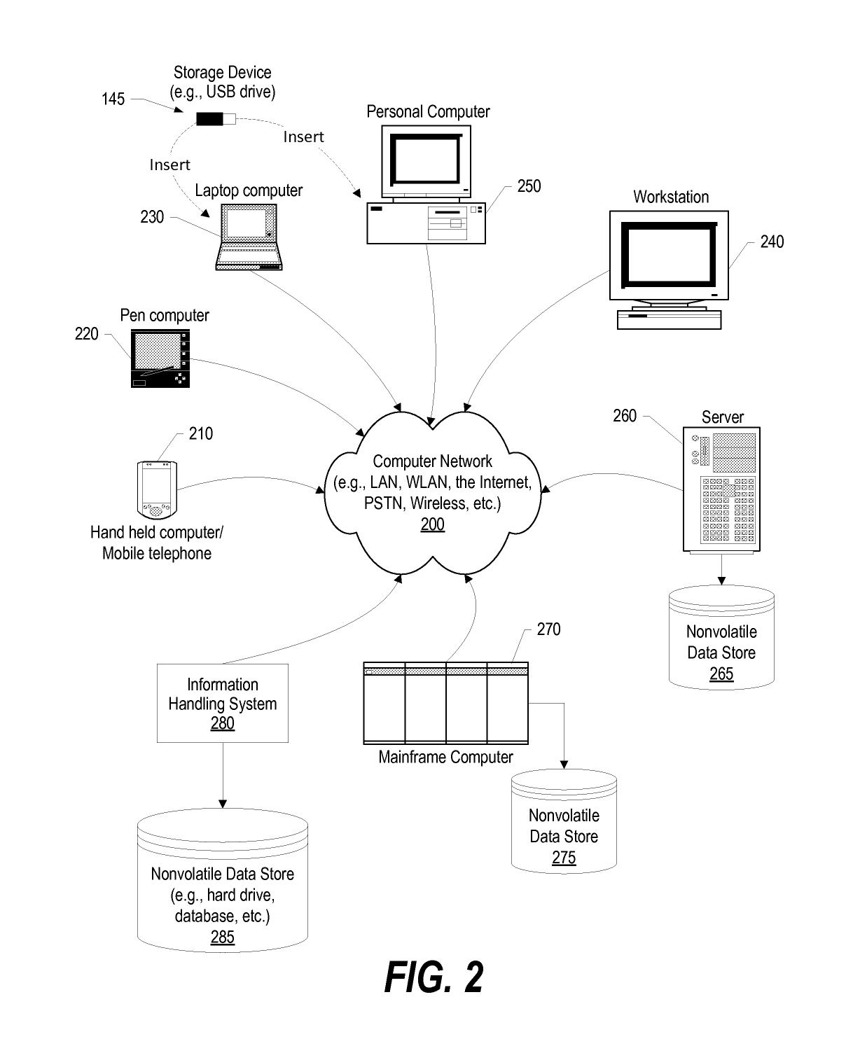

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE .802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

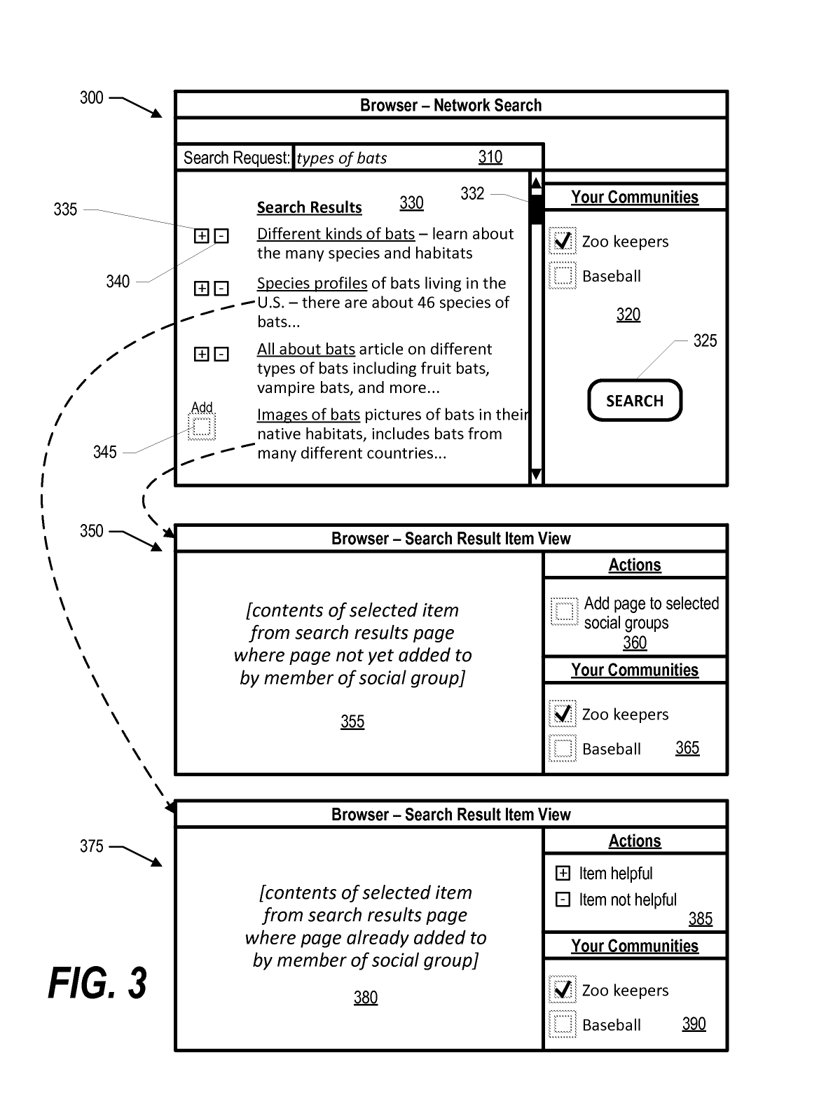

FIGS. 3-5 depict an approach that can be executed on an information handling system, to use social groups to improve search results. In the approach, a user interface is displayed that allows a user to specify a search criteria and one or more social groups. Data stores are then searched for the search criteria with the searching resulting in a set of search results. The search results are compared to previously tagged search results, with the previously tagged search results being results that were previously tagged by members of the specified social groups. Based on the comparing, set of search results is identified that match the previously tagged search results. The search results are displayed at the user interface with the identified set of one or more search results being visually highlighted, such as displayed first, at the user interface. In one embodiment, a ranking for each search result that is included in the set of search results (the matched set of results), with the system sorting the matched set of search results so that the results with a higher ranking are displayed before results with lower rankings. In a further embodiment, a user-based relevance control is selected by the user using the user interface. The relevance control corresponds to a selected one of the search results. If the selected search result has not yet been tagged, then the search result will be retained in the set of previously tagged search results. On the other hand, if the selected search result was already tagged, then the ranking associated with the selected search result will be adjusted based upon whether the user agrees with the inclusion of the search result in the set of tagged results (e.g., “likes” the search result, etc.) in which case the ranking is increased. However, if the user disagrees with inclusion of the search result in the tagged set of results (e.g., “dislikes” the search result, etc.), in which case the ranking is decreased.

FIG. 3 is a screen diagram depicting search result pages that use social groups to improve network search results. User interface, such as a user interface presented at a web browser includes two initial input areas. The initial input areas include search request input field 310 and communities selection area 320.

The user enters a search criteria in search request input field 310 with the search criteria being a search that the user wishes to perform. The user can also select one or more “communities” from communities selection area 320. In one embodiment, the communities selection area includes one or more social groups, such as social media groups, to which the user belongs. The user might belong to such social groups by being a member of the social group at the social media website that provides the social media. In the example shown, the user has entered “types of bats” as the search criteria in search request input field 310. Additionally, two social groups appears in communities selection area 320 (“zoo keepers” and “baseball”) with the user being a member of both of these social groups. The user has selected the “zoo keepers” social group and has not selected the “baseball” social group. In this manner, the user is requesting that the search (“types of bats”) be related to pages found relevant by member of the “zoo keepers” social group and not by members of the “baseball” social group.

The user selects SEARCH command button 325 after entering the search criteria in search request input field 310 and has selecting the desired social groups from the communities selection area 320. In response to selecting SEARCH command button 325, the system searches various data stores for the search criteria, in this case “types of bats.” Since the search engine has no context for the search, the search engine will return all sorts of bats including the mammal as well as baseball bats and other types of bats. To provide the user with results based on the social group (“zoo keepers”) selected by the user, the system compares the search results returned by the search engine with previous search results that were “tagged” by members of the social group, in this case “zoo keepers,” as being relevant to their social group. Based on the comparison, a set of search results returned by the search engine that also match search results previously tagged by members of the social group are identified. This set of identified search results are visually highlighted in search results area 330 of user interface 300. One way that the set of identified search results are visually highlighted in search results area 330 is by displaying this set of search results before displaying search results that did not any of the search results tagged by members of the social group. While only four search results currently appear in search results area 330, the user can scroll down through the search results by using scroll bar 332.

In the example, the first three search results returned were previously tagged by a member of the “zoo keepers” social group as evidenced by the appearance of user-based relevance user controls 335 and 340 appearing proximate to each of the first three search results. User-based relevance control 335, shown as a plus (+) sign is selected by the user to indicate that the user agrees with, or “likes,” the result as being relevant to the social group. By selecting user-based relevance control 335, the ranking of the search result in the “zoo keepers” social group is increased. Conversely, user-based relevance control 340, shown as a minus (−) sign is selected by the user to indicate that the user disagrees with, or “dislikes,” the result as being relevant to the social group. By selecting user-based relevance control 340, the ranking of the search result in the “zoo keepers” social group is decreased. In one embodiment, the rankings associated with each of the set of search results tagged by members of the social group is used to sort the results within the user interface so that results with a higher ranking (e.g., more “likes,” etc.) appear before results with lower rankings (e.g., fewer “likes,” etc.). If a search result

After all search results that are relevant to the selected social groups are displayed, other results that have not been tagged will be displayed. These other results might be results related to the mammalian bat or to baseball bats. The fourth search result shows an example of a search result that has not yet been tagged. This is indicated by a different user-based relevance control appearing proximate to the result (checkbox user-based relevance control 345). By selecting user-based relevance control 345, the user is “tagging” the search result as being relevant to the selected social group, in this case “zoo keepers.”

The user can select user-based relevance control from search results area 330 as well as while viewing a particular search result. When the user selects a search result, a search result item view appears on the user interface. In the case of a previously un-tagged search result, in this example the fourth search result, search result item view 350 is displayed. In screen area 355, the contents of the untagged search result are displayed so that the user can read and review the search result to determine whether the search result is relevant to the user's selected social group. Action panes appear in search result item view 350. These action panes include user-based relevance control pane 360 that allows the user to select the checkbox control in order to “tag” the displayed result and indicate to the members of the social group, in this case “zoo keepers,” that the result is relevant to the group. In addition, an action pane appears as communities selection area 365 showing the user being a member of various social groups (“zoo keepers” and “baseball”). The user can select one or more social groups to which the displayed result is relevant. For example, if the displayed result is regarding wooden baseball bats, then the user could unselect the checkbox next to “zoo keepers” and select the checkbox next to “baseball” to add (“tag”) the result as being relevant to the baseball social group.

Returning to results display area 330, in the case where the user selects a previously tagged search result, in this example one of the first three search results, then search result item view 375 is displayed. In screen area 380, the contents of the previously tagged search result are displayed so that the user can read and review the search result to determine whether the user agrees or disagrees with the inclusion of the result with the social group. Action panes also appear in search result item view 375. These action panes include user-based relevance control pane 385 that allows the user to select a control to indicate whether the user agrees or disagrees that the displayed result is relevant to the social group. As previously described, the user selects the plus sign (+) control to indicate that the user “likes” the result and agrees that it is relevant to the selected social group, and selects the minus sign (−) control to indicate that the user “dislikes” the result and disagrees that it is relevant to the selected social group. The ranking of the result is increased when the user selects the plus sign control and decreased when the user selects the minus sign control. In addition, an action pane appears as communities selection area 390 showing the user being a member of various social groups (“zoo keepers” and “baseball”). The user can select one or more social groups to which the displayed result is relevant. For example, if the displayed result is regarding wooden baseball bats, then the user could unselect the checkbox next to “zoo keepers” and select the checkbox next to “baseball” to add (“tag”) the result as being relevant to the baseball social group.

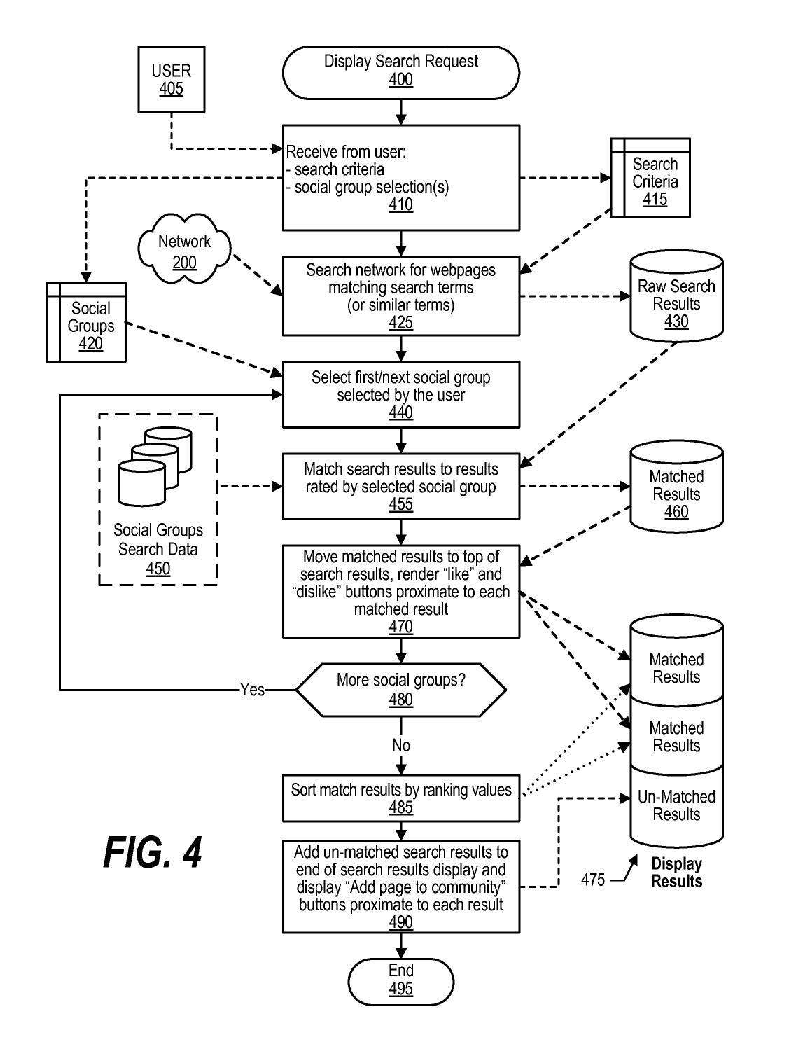

FIG. 4 is a depiction of a flowchart showing the logic performed when processing a search received from a user that is a member of one or more social groups. Process commences at 400 whereupon, at step 410, the process receives the search criteria and the selected user social group(s) from user 405. The search criteria is stored in memory area 415, and the selected social groups are stored in memory area 420.

At step 425, the process searches various data stores, such as by using a search engine that searches computer network 200, such as the Internet, to search for the search criteria. Depending on the sophistication of the search engine, the engine may additionally search for similar terms as well as correct for misspellings found in the search criteria. The search results returned by the search engine are stored in data store 430 as the “raw” search results.

At step 440, the process selects the first social group that was selected by the user. At step 455, the process selects the previously tagged search results for the selected social group from data stores 450 and compares the “raw” search results stored in data store 430 with the tagged search results from the selected social group (with the tagged results being previously tagged as relevant by one or more members of the selected social group). The matched results are stored in data store 460. At step 470, the matched results from data store 460 are moved to the top of the displayed search results (data store 475). In addition, at step 470, user-based relevance controls (e.g., plus/minus signs) are displayed proximate to each of the previously tagged search results.

A decision is made by the process as to whether there are additional social groups to process (decision 480). If there are more social groups that have been selected by the user, then decision 480 branches to the “yes” branch which loops back to select and process the next social group as described above. This looping continues until all social groups have been processed, at which point decision 480 branches to the “no” branch.

At step 485, the matched results are sorted by their individual ranking scores so that results that are higher ranked (e.g., received more “likes” from members of the social group, etc.) appear before lesser ranked results. At step 490, the remainder of the “raw” search results from data store 430 are added to the bottom of the displayed set of results. In addition, at step 490, a user-based relevance control (e.g., a checkbox) is displayed proximate to each of the untagged search results. As previously described, if the user decides that an untagged result is relevant to a social group, the user can “tag” the result by selecting the checkbox control which will add the result to the social group's search data (data stores 450). Subsequent searches performed by this user or other members of the social group would show the newly tagged search result as a “tagged” search result that would appear before untagged search results. Processing thereafter ends at 495.

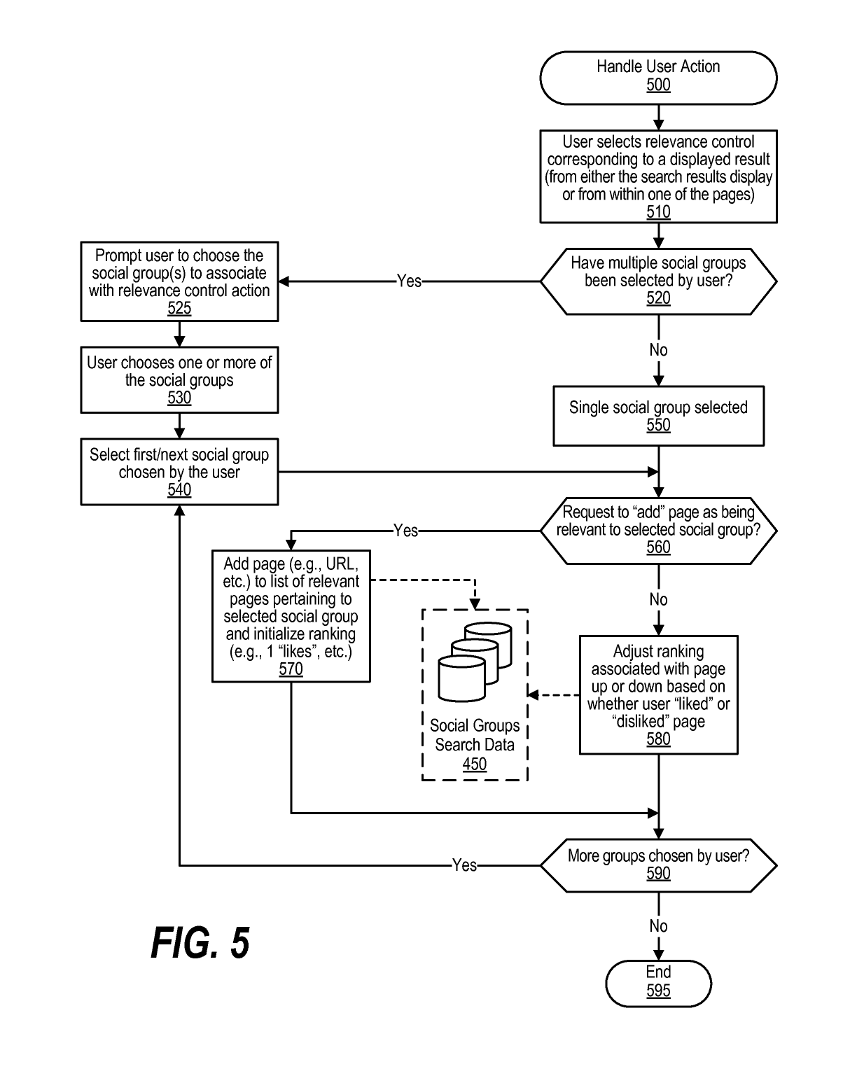

FIG. 5 is a depiction of a flowchart showing the logic performed to handle a user action corresponding to a displayed search result. Processing commences at 500 whereupon, at step 510, the process detects that the user has selected a relevance control corresponding to a displayed result. The relevance control can be from either the search results display (e.g., user interface 300 shown in FIG. 3) or from within one of the search result item view pages (e.g., search result item views 350 and 375 shown in FIG. 3).

A decision is made by the process as to whether multiple social groups have been selected by the user (decision 520). Using the example shown in FIG. 3, the user might have selected both the “zoo keepers” social group as well as the “baseball” social group. If multiple social groups are currently selected, then decision 520 branches to the “yes” branch whereupon, at step 525 the user is prompted to select one or more social groups to associate with the relevance control action that was received from the user. At step 530, the user selects one or more of the social groups as being relevant to the relevance control action. Using the example from FIG. 3, the user may indicate that only the “zoo keepers” social group is relevant and that the “baseball” social group is not relevant to the relevance control action. However, situations may arise where multiple social groups are relevant to a relevance control action. For example, if the user groups included “zoo keepers” and “animal science”, then a search result discussing mammalian bats might be relevant to both of these social groups. At step 540, the first, or perhaps only, social group chosen by the user is selected. Returning to decision 520, if multiple social groups have not been selected by the user (only a single social group has been selected), then decision 520 branches to the “no” branch whereupon, at step 550, the single social group selected by the user is selected.

A decision is made by the process as to whether the user-based relevance control selected by the user is a request to add a new result as being relevant to the selected social group (decision 560). Using the example shown in FIG. 3, the user might have selected checkbox control 345 in search results area 330 or might have selected checkbox control 360 within result item view page 350. If the user-based relevance control selected by the user is a request to add a new result as being relevant to the selected social group, then decision 560 branches to the “yes” branch whereupon, at step 570, the process adds the search result (e.g., URL, etc.) to the list of relevant pages pertaining to selected social group and initializes the ranking of the page (e.g. to 1, etc.). The added search result and initialized ranking are added to social groups search data stores 450 for use by subsequent searches conducted by members of the selected social group.

Returning to decision 560, if the request was not to add a page as being relevant to the selected social group, then the request is to increase or decrease the ranking associated with the page (e.g., “like” or “dislike” the page as being relevant to the social group, etc.). In this case, decision 560 branches to the “no” branch whereupon, at step 580, the process adjusts the ranking up or down based on whether the user “liked” the result (e.g., used a plus sign (+) control as shown in FIG. 3) or “disliked” the result (e.g., used a minus sign (−) control as shown in FIG. 3). In one embodiment, the result is ranked “up” by incrementing the ranking value associated with the result, and the result is ranked “down” by decrementing the ranking value associated with the result. The updated ranking is stored in social groups search data stores 450. In one embodiment, if a ranking for a result is decremented back to zero, then the result is removed from the social groups search data stores (e.g., is no longer “tagged” as being relevant to the selected social group.

A decision is made by the process as to whether there are more social groups chosen by the user to which the user-based relevance control selected by the user should be applied (decision 590). If there are more social groups to process, then decision 590 branches to the “yes” branch which loops back to select and process the next social group as described above. This looping continues until there are no more social groups to process, at which point decision 590 branches to the “no” branch and processing of the user-based relevance control selected by the user ends at 595.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method, in an information handling system comprising a processor and a memory, of using social groups to improve search results, the method comprising:
displaying a user interface that allows a user to specify a search criteria and one or more social groups;
searching one or more data stores for the search criteria, the searching resulting in a plurality of search results;
comparing the plurality of search results to a plurality of previously tagged search results, wherein the previously tagged search results were tagged by members of the one or more specified social groups;
identifying, based on the comparing, a first set of one or more search results from the plurality of search results that match one or more of the previously tagged search results; and
displaying the plurality of search results at the user interface, wherein the displaying visually highlights the identified set of one or more search results.

2. The method of claim 1 further comprising:
visually highlighting the identified set of one or more search results by displaying the identified set of one or more search results before a second set of the plurality of search results that failed to match one or more of the previously tagged search results.

3. The method of claim 2 further comprising:
retrieving a ranking corresponding to each of the search results included in the first set of one or more search results, wherein the visually highlighting further comprises sorting the identified set of one or more search results by the retrieved rankings.

4. The method of claim 3 further comprising:
receiving, at the user interface, a user-based relevance control corresponding to a selected one of the search results included in the first set of the plurality of search results; and
adjusting the ranking corresponding to the selected one of the search results based on the user-based relevance control.

5. The method of claim 3 further comprising:
receiving, at the user interface, a user-based relevance control corresponding to a selected one of the search results included in the first set of the plurality of search results;
increasing the ranking corresponding to the selected one of the search results in response to the user-based relevance control being a positive relevance control; and
decreasing the ranking corresponding to the selected one of the search results in response to the user-based relevance control being a negative relevance control.

6. The method of claim 2 further comprising:
receiving, at the user interface, a user-based selection corresponding to a selected one of the search results included in the second set of the plurality of search results; and
storing the selected one of the search results in the plurality of previously tagged search results.

7. The method of claim 1 wherein at least one of the social groups is a community in a social media website to which the user is a member.

8. An information handling system comprising:
one or more processors;
a memory coupled to at least one of the processors; and
a set of instructions stored in the memory and executed by at least one of the processors to use social groups to improve search results, wherein the set of instructions perform actions of:
displaying a user interface that allows a user to specify a search criteria and one or more social groups;
searching one or more data stores for the search criteria, the searching resulting in a plurality of search results;
comparing the plurality of search results to a plurality of previously tagged search results, wherein the previously tagged search results were tagged by members of the one or more specified social groups;
identifying, based on the comparing, a first set of one or more search results from the plurality of search results that match one or more of the previously tagged search results; and
displaying the plurality of search results at the user interface, wherein the displaying visually highlights the identified set of one or more search results.

9. The information handling system of claim 8 wherein the actions further comprise:
visually highlighting the identified set of one or more search results by displaying the identified set of one or more search results before a second set of the plurality of search results that failed to match one or more of the previously tagged search results.

10. The information handling system of claim 8 wherein the actions further comprise:
retrieving a ranking corresponding to each of the search results included in the first set of one or more search results, wherein the visually highlighting further comprises sorting the identified set of one or more search results by the retrieved rankings.

11. The information handling system of claim 10 wherein the actions further comprise:
receiving, at the user interface, a user-based relevance control corresponding to a selected one of the search results included in the first set of the plurality of search results; and
adjusting the ranking corresponding to the selected one of the search results based on the user-based relevance control.

12. The information handling system of claim 10 wherein the actions further comprise:
receiving, at the user interface, a user-based relevance control corresponding to a selected one of the search results included in the first set of the plurality of search results;
increasing the ranking corresponding to the selected one of the search results in response to the user-based relevance control being a positive relevance control; and
decreasing the ranking corresponding to the selected one of the search results in response to the user-based relevance control being a negative relevance control.

13. The information handling system of claim 9 wherein the actions further comprise:
receiving, at the user interface, a user-based selection corresponding to a selected one of the search results included in the second set of the plurality of search results; and
storing the selected one of the search results in the plurality of previously tagged search results.

14. The information handling system of claim 8 wherein at least one of the social groups is a community in a social media website to which the user is a member.

15. A computer program product stored in a computer readable storage medium, comprising computer instructions that, when executed by an information handling system, causes the information handling system to use social groups to improve search results by performing actions comprising:
displaying a user interface that allows a user to specify a search criteria and one or more social groups;
searching one or more data stores for the search criteria, the searching resulting in a plurality of search results;
comparing the plurality of search results to a plurality of previously tagged search results, wherein the previously tagged search results were tagged by members of the one or more specified social groups;
identifying, based on the comparing, a first set of one or more search results from the plurality of search results that match one or more of the previously tagged search results; and
displaying the plurality of search results at the user interface, wherein the displaying visually highlights the identified set of one or more search results.

16. The computer program product of claim 15 wherein the actions further comprise:
visually highlighting the identified set of one or more search results by displaying the identified set of one or more search results before a second set of the plurality of search results that failed to match one or more of the previously tagged search results.

17. The computer program product of claim 16 wherein the actions further comprise:
retrieving a ranking corresponding to each of the search results included in the first set of one or more search results, wherein the visually highlighting further comprises sorting the identified set of one or more search results by the retrieved rankings.

18. The computer program product of claim 17 wherein the actions further comprise:
receiving, at the user interface, a user-based relevance control corresponding to a selected one of the search results included in the first set of the plurality of search results; and
adjusting the ranking corresponding to the selected one of the search results based on the user-based relevance control.

19. The computer program product of claim 17 wherein the actions further comprise:
receiving, at the user interface, a user-based relevance control corresponding to a selected one of the search results included in the first set of the plurality of search results;
increasing the ranking corresponding to the selected one of the search results in response to the user-based relevance control being a positive relevance control; and
decreasing the ranking corresponding to the selected one of the search results in response to the user-based relevance control being a negative relevance control.

20. The computer program product of claim 16 wherein the actions further comprise:
receiving, at the user interface, a user-based selection corresponding to a selected one of the search results included in the second set of the plurality of search results; and
storing the selected one of the search results in the plurality of previously tagged search results.
